(19) United States
(12) Patent Application Publication
(10) Pub. No.: US 2012/0221481 A1
(43) Pub. Date: Aug. 30, 2012

(54) System and Method for Variable Annuity Financial Product Illustrations

(76) Inventors: Robert Dwyer, New Britain, CT (US); Kurt Mansfield, Southington, CT (US)

(21) Appl. No.: 13/035,247

(22) Filed: Feb. 25, 2011

(51) Int. Cl. G06Q 40/00

(52) U.S. Cl. 705/36 R

(57) ABSTRACT

System and methods for variable annuity financial product illustrations are provided. A computer system generates user interface screen(s) allowing the user to specify information about a variable annuity financial product to be illustrated, and a desired start date for a financial illustration. An illustration server receives the information and desired start date from the computer system. Historical performance data relating to at least one portfolio of the variable annuity financial product is obtained, and the variable annuity financial product is modeled to produce a first illustration for the variable annuity financial product. The variable annuity financial product is also modeled with a benefit associated with the variable annuity financial product, to produce a second illustration for the variable annuity financial product. An illustration report is created, allowing the user to compare performance of the variable annuity financial product during the illustration period with and without the benefit.

### BACKGROUND OF THE INVENTION

1. Field of the Invention

The present invention relates generally to the field of financial planning. More specifically, the present invention relates to a system and method for variable annuity financial product illustrations.

2. Related Art

In the financial services field, it is common to model or “illustrate” the past performance of a financial product, to assist with financial planning and to allow informed decisions to be made as to investments. Often, such modeling occurs with the use of a computer system, and the results of the illustration are displayed to a user in graph or tabular format. Unfortunately, in the area of variable annuities, existing illustration systems have limited flexibility in terms of start dates, lack of daily calculations, and no ability to make comparisons between different benefits that may be offered with the variable annuity.

In the retirement planning services profession, it is desirable to illustrate the performance of a variable annuity at a specific date in the past and extending to the present. Also, it is desirable to illustrate performance of a variable annuity on a daily basis, and to allow the variable annuity to be illustrated when one or more benefits are provided with the variable annuity, such as a living benefit or a protected withdrawal benefit, to facilitate informed decision making. The present invention addresses these and other needs.

### SUMMARY OF THE INVENTION

The present invention relates to systems and methods for variable annuity financial product illustrations. In one embodiment, the system includes a local computer system operated by a user, the local computer system generating at least one user interface screen for allowing the user to specify information about a financial product to be illustrated and a desired start date for a financial illustration, and an illustration server in communication with the local computer system, the illustration server receiving the information about the financial product and the desired start date from the local computer system. Historical performance data on a daily basis is obtained relating to at least one portfolio of the variable annuity financial product, and performance data is calculated for at least one portfolio having a benefit associated with the variable annuity financial product. The financial product is modeled to produce a first illustration for the variable annuity financial product and to produce a second illustration of the variable annuity financial product with at least one benefit associated with the variable annuity financial product, for comparison of the variable annuity financial product with and without the at least one benefit. An illustration report is generated for the user, and includes the first and second illustrations. The illustration report is transmitted to the user and displayed on the local computer system. The illustration report allows the user to compare performance of the variable annuity financial product to performance of the variable annuity financial product during the same illustration period where the variable annuity financial product includes one or more benefits associated therewith, such as a living benefit or a protected (guaranteed minimum) withdrawal value.

In another embodiment, the present invention provides a method for illustrating a variable annuity financial product. The method comprises the steps of generating at least one user interface screen at a local computer operated by a user; allowing the user to specify information about a variable annuity financial product to be illustrated and a desired start date for a financial illustration, using the at least one user interface screen; transmitting the information about the variable annuity financial product and the desired start date from the local computer system to an illustration server in communication with the local computer system; electronically obtaining historical performance data on a daily basis relating to at least one portfolio of the variable annuity financial product; calculating performance data for at least one portfolio having a benefit associated with the variable annuity financial product; modeling the variable annuity financial product from the start date to an end date using the illustration server to produce a first illustration for the variable annuity financial product; modeling the variable annuity financial product with at least one benefit associated with the variable annuity financial product over the same time period using the illustration server to produce a second illustration for the variable annuity financial product; generating an illustration report for the user, the illustration report including the first and second illustrations for comparison of the variable annuity financial product with and without the at least one benefit; transmitting the illustration report to the local computer system; and displaying the report to the user on the local computer system.

In another embodiment, the present invention provides a computer-readable storage medium having computer-readable instructions for instructing at least one computer system to generate an illustration of a variable annuity financial product. The instructions cause the at least one computer system to execute the steps of: electronically obtaining historical performance data on a daily basis relating to at least one portfolio of the variable annuity financial product; calculating performance data for at least one portfolio having a benefit associated with the variable annuity financial product; modeling the variable annuity financial product from the start date to an end date using the illustration server to produce a first illustration for the variable annuity financial product; modeling the variable annuity financial product with at least one benefit associated with the variable annuity financial product over the same time period using the illustration server to produce a second illustration for the variable annuity financial product; generating an illustration report for the user, the illustration report including the first and second illustrations for comparison of the variable annuity financial product with and without the at least one benefit; transmitting the illustration report to the local computer system; and displaying the report to the user on the local computer system.

The present invention also provides a system comprising a computer-readable medium alone and/or in combination with additional apparatus. For example, the illustration server can comprise the computer readable medium, which can have program code, which, when executed, causes execution of the following steps: providing information about at least one portfolio of a variable annuity financial product to be illustrated and a desired time period including desired start date for illustration; providing historical performance data on a daily basis relating to the at least one portfolio; calculating performance data for the at least one portfolio; modeling (a) the at least one portfolio from the start date to an end date to produce a first illustration and (b) the at least one portfolio with at least one benefit for the same time period to produce a second illustration; and generating an illustration report based on the first and second illustrations for comparison of the at least one portfolio with and without the at least one benefit.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing the variable annuity variable annuity financial product illustration system of the present invention;

FIG. 2 is a diagram showing hardware components of the illustration server of the present invention, in greater detail;

FIG. 3 is a flowchart showing processing steps carried out by the present invention for generating variable annuity financial product illustrations;

FIG. 4 is a flowchart showing the modeling step of FIG. 3 in greater detail;

FIG. 5 is a flowchart showing the illustration report generation step of FIG. 3 in greater detail;

FIGS. 6A-6E are screenshots of the user interface generated by the present invention for allowing a user to conduct an illustration of a variable annuity financial product;

FIGS. 7A-7J are screenshots showing a sample variable annuity financial product illustration report generated by the present invention; and

FIGS. 8A-8D are screenshots showing excerpts of another sample variable annuity financial product illustration report generated by the present invention, wherein multiple portfolios are included in the illustration.

### DETAILED DESCRIPTION OF THE INVENTION

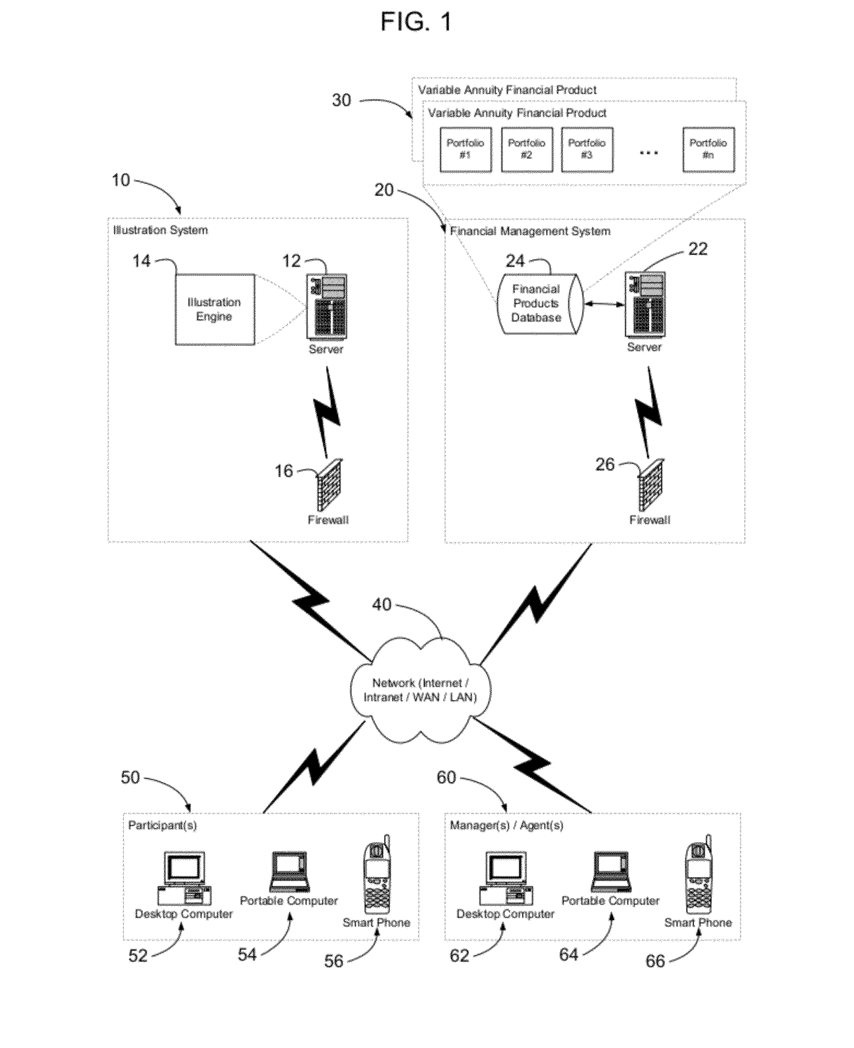

The present invention relates to a system and method for variable annuity financial product illustrations, as discussed in detail below in connection with FIGS. 1-8D.

FIG. 1 is a diagram showing the variable annuity financial product illustration system of the present invention, indicated generally at 10. The system 10 includes an illustration server 12, an illustration software engine 14 stored on and executed by the illustration server 12, and, optionally, a firewall 16. As will be discussed in greater detail below, the system 10 provides a web-based system for illustrating and comparing the account value of an account having one or more portfolios produced by one or more variable annuity financial products, over a user-defined time period extending from a selected start date in the past to a pre-defined end date (e.g., up to the most recent month's end), using actual (historical) financial performance data. The system 10 allows a user to model a desired hypothetical investment scenario using daily historical performance data, and calculates returns for the scenario that are representative of actual returns that the user would have received during the modeled time period. Servers discussed herein, such as the illustration server 12, for example, can be any desired computer server hardware (e.g., a server or servers having single or multiple processors, single or multiple processor cores, “blade” servers, etc.) having any desired hardware architecture (e.g., Intel x86, Sun SPARC, etc.). Further, the server 12 could run any desired operating system, such as Unix, Linux, Microsoft Windows, MacOS, Solaris, etc.

The system 10 communicates with a financial management system 20, which contains information about one or more variable annuity financial products 30 held by one or more clients of a financial institution. The variable annuity financial products 30 include a plurality of financial portfolios, illustratively labeled in FIG. 1 as portfolios 1 through n, n being any desired integer. The portfolios could be asset allocation portfolios, each of which could include a plurality of funds, stocks, bonds, and/or other financial instruments. Data about each variable annuity financial product 30 is processed by a server 22 and stored in a financial products database 24. Optionally, a firewall 26 could be provided for securing the server 22. The illustration system 10 and the financial management system 20 could communicate with each other over a network 40, which could include, but is not limited to, the Internet, an intranet, a wide area network (WAN), local area network (LAN), wireless network, etc. The illustration system 10 obtains information about the one or more financial accounts 30 from the financial management system 20, and processes this information to generate a customized illustration for the financial account that is presented to a user in a customized, web-based user interface.

The system 10 permits one or more users, such as a participant 50 having an account with a financial institution, to create customized illustrations for his or her financial product, beginning at a desired time. A customized user interface is provided for the participant and is accessible using a web browser executing on any desired computer system, such as a desktop computer 52, a portable computer 54 (e.g., laptop computer, tablet computer, personal digital assistant (PDA), etc.), a smart phone 56, etc. The user interface allows the participant to provide information to be utilized in generating an illustration of a selected financial product. This information, once provided by the participant, could be transmitted to the illustration server 12 via the network 40 as Extensible Markup Language (XML) data, or in any other suitable format. Once received, the illustration server 12 processes the data, and obtains information about the participant's financial product from the financial management system 20, including, but not limited to, historical performance data relating to the user's variable annuity financial product. This information could be provided to the illustration server 12 from the financial management system 20 as XML data, or in any other suitable format. The illustration system 12 then processes the information using the illustration engine 14 to generate a model of the participant's variable annuity financial product over a desired period of time, thereby simulating actual returns that the participant would have earned had the participant actually invested in accordance with the parameters specified for the simulation. The scenario could be modeled by the server 12 on a daily basis, to provide precise simulation results.

The raw modeled data is transmitted by the illustration server 12 to the financial management system 20, whereupon the server 22 generates a customized report for the participant 50. This report, once generated, is transmitted to the participant 50 over the network 40, for display on the participant's local computer system. The report could be formatted in any suitable format, such as Adobe Postscript Data Format (PDF), or any other suitable format. It is noted that the server 22 need not generate such a report, but rather, the illustration server 12 could itself be programmed to generate the report and to transmit it to the participant.

It is noted that the same functionality provided by the system 10 for the participant(s) 50 could also be provided to one or more financial manager(s)/agent(s) 60. Similar to the participant(s) 50, the financial manager(s)/agent(s) 60 could operate any desired local computer system, such as a desktop computer 62, portable computer 64 (e.g., laptop, tablet computer, PDA, etc.), and/or smart phone 66. Also, it is noted that the devices 52-56 and 62-66 could operate any desired computer operating system, such as Microsoft Windows, Windows Mobile, Unix, Linux, etc. Also, it is noted that systems 10 and 20 can be integrated, such that the hardware and/or software components of system 10 perform the functionality of system 20, and vice versa. Similarly, the systems 10 and 20 can each be distributed computing systems.

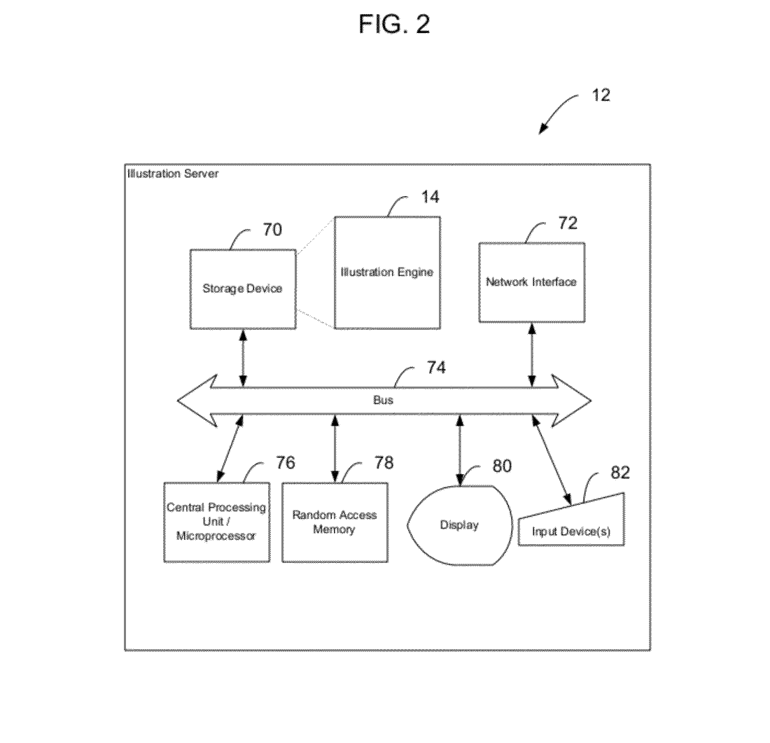

FIG. 2 is a diagram showing hardware and software components of the illustration server 12 of the present invention, in greater detail. The illustration server 12 includes a storage device 70, a network interface device 72, a communications bus 74, a central processing unit (CPU) 76, a random access memory (RAM) 78, a display 80, and one or more input devices 82, such as a keyboard, mouse, etc. The storage device 70 could comprise any suitable computer-readable storage medium such as disk, non-volatile memory (e.g., EPROM, EEPROM, flash memory), etc. The illustration engine 14 of the present invention could comprise computer-readable program code stored on the storage device 70 and executed by the CPU 76, and could be coded using any suitable, high- or low-level computing language, such as Java, C, C++, C#, .NET, etc. The network interface 72 could include an Ethernet network interface device, a wireless network interface device, or any other suitable device which permits the server 12 to communicate via the network 40 of FIG. 1. The CPU 76 could include any suitable single- or multiple-core microprocessor. It is contemplated that server 22 can be provided with hardware and/or software components similar to those of server 12, and/or additional and/or alternative components.

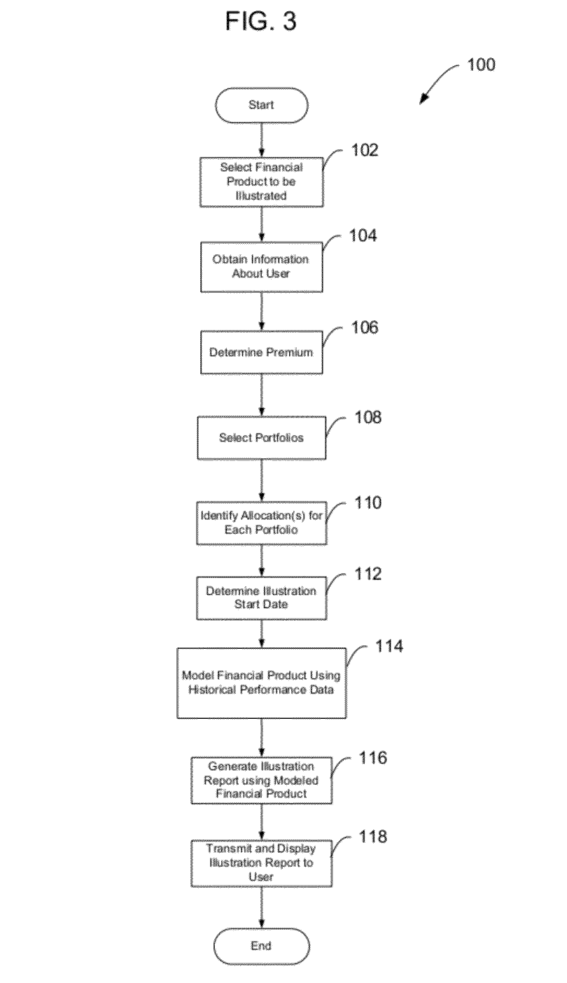

FIG. 3 is a flowchart showing processing steps, indicated generally at 100, that are carried out by the variable annuity financial product illustration system 10 of the present invention. Such steps are executed by the illustration engine 14 of the server 12, and/or could be distributed across more than one computing system. Beginning in step 102, the system 10 generates one or more web-based user interface screens that are transmitted to a user (e.g., the users 50 and/or 60 of FIG. 1) and displayed in a web browser, and which allows the user to select a variable annuity financial product to be illustrated. Examples of such products include, but are not limited to, the Prudential Premiere Retirement Variable Annuities (Series B, C, L, and/or X), and/or the Prudential Premiere Advisor's Variable Annuity. In step 104, information about the user is obtained, using the web-based user interface. Examples of user information that can be obtained include, but are not limited to, client name, joint name, annuitant name, trust name, producer name, license number, firm name, etc. Other information related to the user's variable annuity financial product could also be obtained, such as information about a rider accompanying an annuity, a case name/identifier, state in which the variable annuity financial product has been issued, etc.

In step 106, the premium value of the user's variable annuity financial product is determined. This information could be specified by the user, or retrieved from the financial products database 24 of FIG. 1. Then, in step 108, the present invention permits the user, using the web-based user interface, to select one or more portfolios of the variable annuity financial product to be included in the illustration. Examples of such portfolios include, but are not limited to, asset allocation portfolios (which may include an optional living benefit), or any other type of portfolio. In step 110, the user can identify allocations of the selected portfolio(s). Such allocations could be expressed as U.S. dollar (or foreign currency) value (such as $40,000 USD for fund no. 1, $30,000 USD for fund no. 2, $20,000 USD, etc.) or percentages (e.g, 40% for fund no. 1, 30% for fund no. 2, and 20% for fund no. 3) (inter-portfolio allocations). Also, allocations across multiple portfolios (intra-portfolio allocations) could also be performed. Once portfolio(s) and allocation(s) have been specified by the user, step 112 occurs, wherein the user specifies a desired illustration start date, i.e., a date in the past from which to begin illustrating performance of the variable annuity financial product, extending to a pre-defined end date (which, for example, could be the most recent month's end, or the present date).

In step 114, the variable annuity financial product is calculated and modeled over the specified time period using actual (historical) performance data, as well as the information supplied by the user (e.g., the premium value). The historical performance data could comprise daily historical performance data of the portfolio(s) included in the variable annuity financial product, and could be obtained from the financial management system 20 or any other suitable source. When the modeling is complete, step 116 occurs, wherein an illustration report is generated for the user using the raw modeled data. As discussed above, this report could be a PDF file (or in any other suitable file format) which includes detailed information about returns generated by the financial product during the time period. Finally, in step 118, the report is transmitted and displayed to the user.

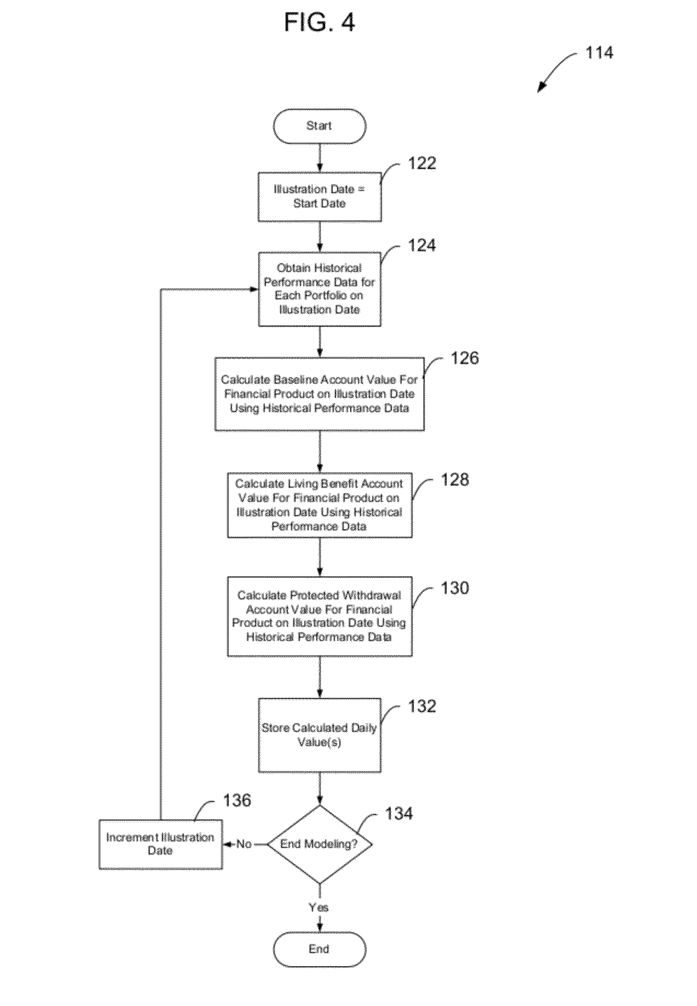

FIG. 4 is flowchart showing the modeling step 114 of FIG. 1 in greater detail. Importantly, the models generated by the present invention allow a variable annuity financial product to be compared with one or more benefits offered with the product, to facilitate informed financial planning. As mentioned above, the modeling carried out by the present invention is done on a daily basis, so as to provided precise simulation results. Beginning in step 122, the illustration date for the current simulation iteration is initially set to the start date specified by the user. Then, in step 124, historical performance data is obtained for each portfolio, for the current illustration date. That is, the performance data indicates how the each portfolio performed in the market on the illustration date.

In step 126, a baseline account value is calculated for the variable annuity financial product for the current illustration date. This value represents the actual value of the variable annuity financial product on the illustration date in view of performance of the portfolio(s) forming the variable annuity financial product on the illustration date. The baseline account value could be expressed as an annuity unit value (AUV), and could be calculated using a net asset value (NAV) corresponding to one or more funds or other financial instruments forming the portfolio(s) of the financial product, and could take into account fees such as mortality and expense (M&E) fees charged by a financial institution, as well as other fees. For example, the AUV for the financial product for the current illustration day could be calculated according to the following equation:

AUV=((NAV of prior day/NAV of illustration day)−daily M&E*AUV of prior day Equation 1

M&E fees are normally expressed as yearly values, but could be expressed as daily values by the present invention using the following equation:

M&E=1−(1−r)^{(1/365)} Equation 2

where r=a pre-defined M&E percentage for the financial product being illustrated. Of course, the equations discussed herein could be modified to compensate for a leap year, if desired.

It is also noted that annual fees, payable to a provider of the variable annuity financial product, could also be calculated in step 126. For example, an annual fee could be calculated which is the lesser of a pre-defined dollar value (e.g., $50) or a pre-defined percentage (e.g., 2%) of the account value. Also, for accounts greater than or equal to a pre-defined amount (e.g., $100,000), the annual fee could be waived. The annual fee could be factored into the illustrations generated by the present invention.

In step 128, the present invention calculates a living benefit account value for the variable annuity financial product on the illustration date, using the historical performance data. This value represents the value of the variable annuity financial product on the illustration date if the financial product is tied to an option/benefit such as a living benefit (a “rider”). An example of such a product is described in detail in co-pending U.S. patent application Ser. No. 11/404,979, the entire disclosure of which is expressly incorporated herein by reference. The aforementioned calculations set forth in Equations 1 and 2 could also be used to calculate the living benefit account value for the illustration day, and the results adjusted to accommodate the living benefit option. For example, the Equations 1 and 2 could take into account an “Ax” factor, which determines an amount of income benefit to be provided during a person's life. Also, the calculations of the present invention could incorporate a “self-hedging” feature, wherein a daily percentage of the variable annuity financial product is moved to a stable bond account, so as to guard against market risk. It is also noted that other types of benefits associated with the variable annuity financial product could be modeled, such as death benefits, etc.

In step 130, the present invention calculates a protected withdrawal account value for the variable annuity financial product on the illustration date, using the historical performance data. This value represents the value of the variable annuity financial product on the illustration date if the variable annuity financial product provides a guaranteed minimum withdrawal value. The protected withdrawal account value is guaranteed to never fall below a pre-defined growth rate (e.g., an annual growth rate of 6%, spread over 365 days or even a leap year, if applicable), but could also be higher than the pre-defined growth rate if the aggregate performance of the funds (and/or other financial instruments) forming the portfolios of the variable annuity financial product exceed the pre-defined growth rate.

Calculation of the daily values could be carried out by the present invention utilizing one or more valuation formulas/equations tailored to a specific financial product to be illustrated. One example is given hereinbelow, for calculating daily values in connection with the Highest Daily Lifetime 6 financial product offered by Prudential Financial, Inc. The example given hereinbelow is provided for illustration purposes only, could be varied based upon the specific financial product being illustrated, and is not intended to limit the spirit or scope of the present invention.

First, the following terms are first defined:
Cᵤ—the upper target is established on the effective date of the benefit (the “Effective Date”) and is not changed for the life of the guarantee. It could be, for example, a percentage such as 83%;
Cᵤₛ—The secondary upper target is established on the Effective Date of the benefit and is not changed for the life of the guarantee. It could be, for example, a percentage such as 84.5%;
Cₜ—the target is established on the Effective Date and is not changed for the life of the guarantee. It could be, for example, a percentage, such as 80%;
Cₗ—the lower target is established on the Effective Date and is not changed for the life of the guarantee. It could be, for example, a percentage, such as 78%;
L—the target value as of the current valuation day;
r—the target ratio;
a—factors used in calculating the target value. These factors are established on the Effective Date and are not changed for the life of the guarantee, and could be numeric values between a pre-defined range, such as 4.06-15.34;
Vᵥ—the total value of all permitted sub-accounts in the annuity;
V_{F}—the unadjusted account value of all pertinent elected options in the annuity;
B—the total value of the bond portfolio sub-account;
P—income basis. Prior to the first lifetime withdrawal, the income basis is equal to the protected withdrawal value calculated as if the first lifetime withdrawal were taken on the date of calculation. After the first lifetime withdrawal, the income basis is equal to the greater of (1) the protected withdrawal value on the date of the first lifetime withdrawal, increased for additional purchase payments, and adjusted proportionally for excess income, and (2) the protected withdrawal value on any annuity anniversary subsequent to the first lifetime withdrawal, increased for subsequent additional Purchase Payments and adjusted proportionately for excess income, and (3) any highest daily unadjusted account value occurring on or after the later of the immediately preceding annuity anniversary, or the date of the first lifetime withdrawal, and prior to or including the date of this calculation, increased for additional purchase payments and adjusted for withdrawals, as described herein;
T—the amount of a transfer into or out of the bond portfolio sub-account; and
T_{M}—the amount of a monthly transfer out of the bond portfolio sub-account.

On each valuation day, a target value (L) is calculated, according to the following formula. If (V_{V}+V_{F}) is equal to zero, no calculation is necessary. Target values are subject to change for new elections of this benefit on a going-forward basis:

L=0.05*P*a Equation 3

A daily transfer calculation is also carried out. The following formula, which is set on the benefit effective date and is not changed for the life of the guarantee, determines when a transfer is required:

Target Ratio r=(L−B)/(V_{V}+V_{F}) Equation 4

If, on the third consecutive valuation day, r>Cᵤ and r (less or =) Cᵤₛ or if on any day r>Cᵤₛ, and transfers have not been suspended due to the 90% cap rule (discussed below), assets in the permitted sub-accounts and the options, if applicable, are transferred to the bond portfolio sub-account.

If r<Cₗ, and there are currently assets in the bond portfolio sub-account (B>0), assets in the bond portfolio sub-account are transferred to the permitted sub-accounts as described above.

A “90% Cap Rule” could be implemented, as follows. If, on any valuation day this benefit remains in effect, a transfer into the bond portfolio sub-account occurs that results in 90% of the unadjusted account value being allocated to the bond portfolio sub-account, any transfers into the bond portfolio sub-account will be suspended, even if the formula would otherwise dictate that a transfer into the bond portfolio sub-account should occur. Transfers out of the bond portfolio sub-account and into the elected sub-accounts will still be allowed. The suspension will be lifted once a transfer out of the bond portfolio sub-account occurs either due to a daily or monthly transfer calculation. Due to the performance of the bond portfolio sub-account and the elected sub-accounts, the unadjusted account value could be more than 90% invested in the bond portfolio sub-account.

The following formula, which is set on the benefit effective date and is not changed for the life of the guarantee, determines the transfer amount:

T=Min(Max(0,(0.90*(V_{V}+V_{F}+B))−B),[L−B−(V_{V}+V_{F})*Cₜ]/(1−Cₜ)) Equation 5

This results in money being transferred from the permitted sub-accounts and the options to the bond sub-account. Further,

T={Min(B,−[L−B−(V_{V}+V_{F})*Cₜ]/(1−Cₜ))} Equation 6

results in money being transferred from the bond sub-account to the permitted sub-accounts.

On each monthly anniversary of the annuity issue date and following the daily transfer calculation above, the following formula determines if a transfer from the bond sub-account to the permitted sub-accounts will occur:

If, after the daily transfer calculation is performed, {Min(B,0.05*(V_{V}+V_{F}+B))}(less than)(Cu*(V_{V}+V_{F})−L+B)/(1−Cu), then TM={Min(B,0.05*(V_{V}+V_{F}+B))} Equation 7

As a result, money is transferred from the bond sub-account to the permitted sub-accounts.

In step 132, once the calculated daily values have been generated, they are stored by the present invention for use in generating, for comparison purposes, illustration of the variable annuity financial product when one or more benefits are provided with the variable annuity financial product. Then, in step 134, a determination is made as to whether to end modeling. If a positive determination is made, modeling ends. Otherwise, step 136 occurs, wherein the current illustration date is incremented by a day. Then, control returns to step 124 so that additional modeling can occur.

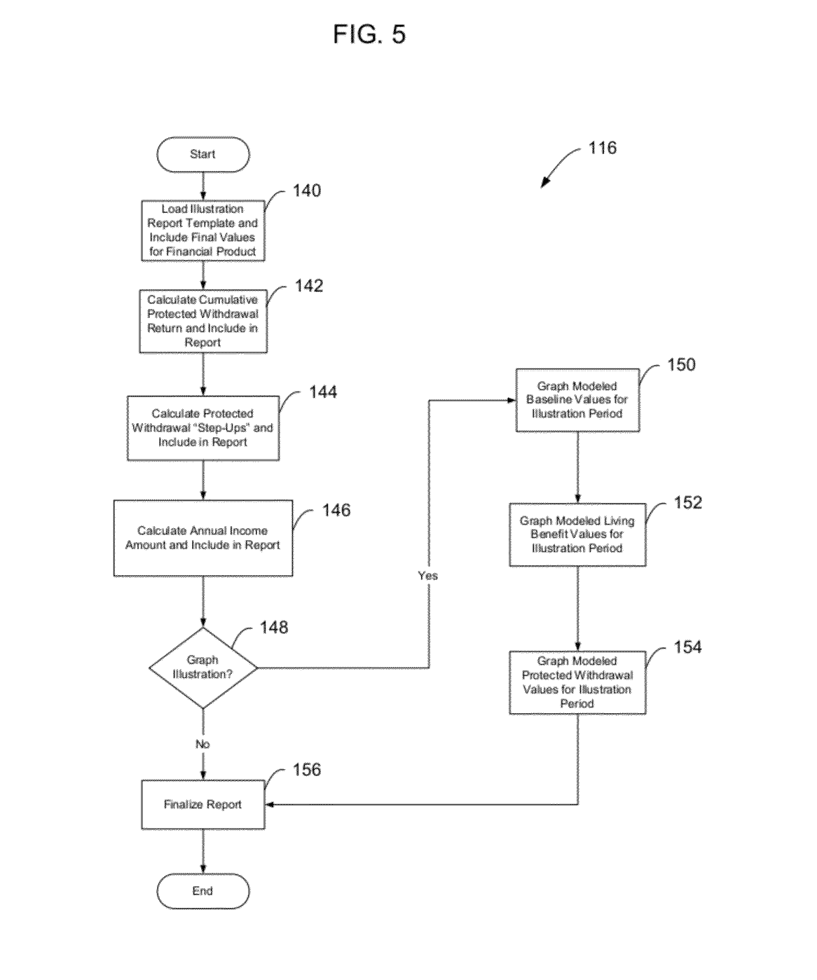

Creation of the illustrations generated by the present invention will now be discussed with respect to FIG. 5, which is a flowchart showing the illustration generation step 116 of FIG. 3 in greater detail. In step 140, a template illustration report is loaded (e.g., by the illustration system 10 or the financial management system 20). The template contains formatting and/or contents that are common to each illustrated generated by the present invention. Included in the template are final values for the variable annuity financial product for the illustration period. These could include, for example, the final value for the variable annuity financial product where no living benefit or protected withdrawal option is provided, a final value for the variable annuity financial product where a living benefit is provided, and/or a final value for the variable annuity financial product where a protected withdrawal option is provided. In so doing, the invention allows for comparison of the variable annuity financial product's performance using actual performance data and taking into account various benefits/options that can be offered for the variable annuity financial product.

In step 142, the a cumulative protected withdrawal return (expressed as a percentage) is calculated and included in the report. This percentage represents the return provided during the illustration period by the variable annuity financial product when it is offered with a guaranteed (protected) withdrawal option, and could be calculated as follows:

PWV Cumulative Return=(Ending PWV−Beginning PWV)/Beginning PWV Equation 8

In step 144, protected withdrawal “step-ups” are calculated, and are included in the report. The step-ups represent the total number of daily instances where the actual return of the variable annuity financial product exceeds the guaranteed minimum return value (in instances where the variable annuity financial product is offered with the protected withdrawal benefit). In step 146, an annual income amount is calculated and included in the report. This amount represents the annual amount of income provided by the variable annuity financial product. It could reflect an optional living benefit, and/or the aforementioned protected withdrawal benefit. In step 148, a determination is made as to whether to graph the modeled values of the illustration (over the specified time period), and to include such graphs in the illustration report. If a positive determination is made, steps 150-154 occur, wherein the modeled baseline, living benefit, and/or protected withdrawal values are graphed over the illustration time period, and are included in the report. Of course, the modeled data could also be presented in another format, such as in tabular format. Finally, in step 156, the report is finalized so that it can be transmitted to the user.

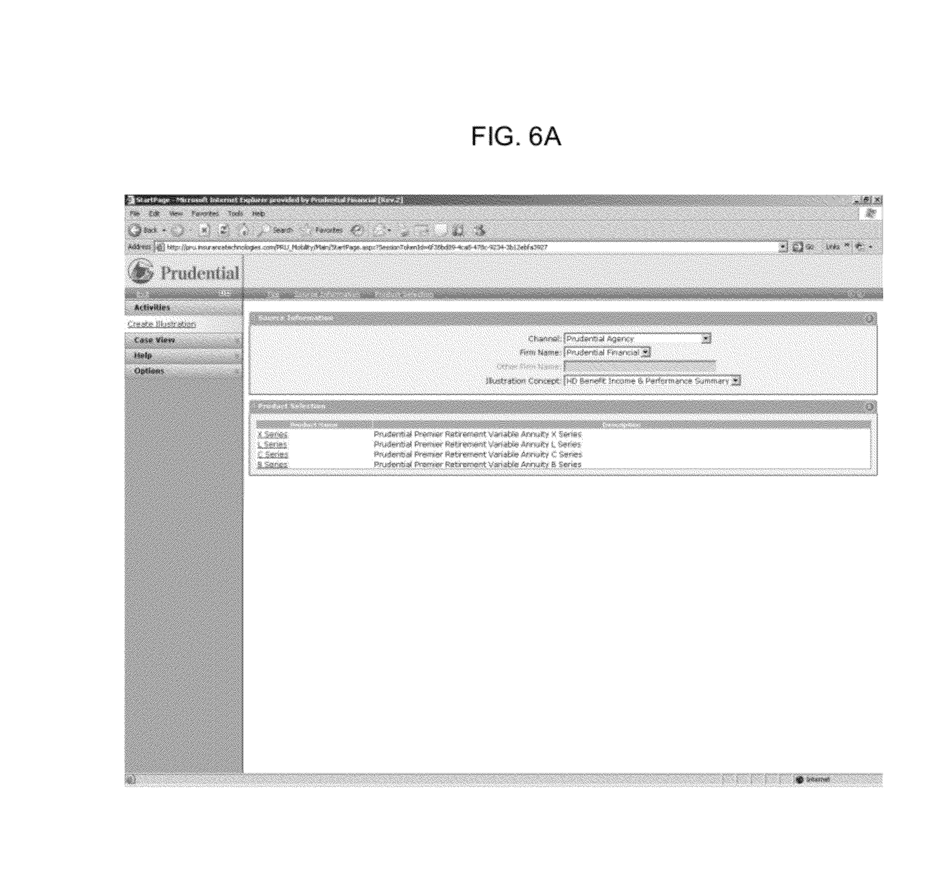

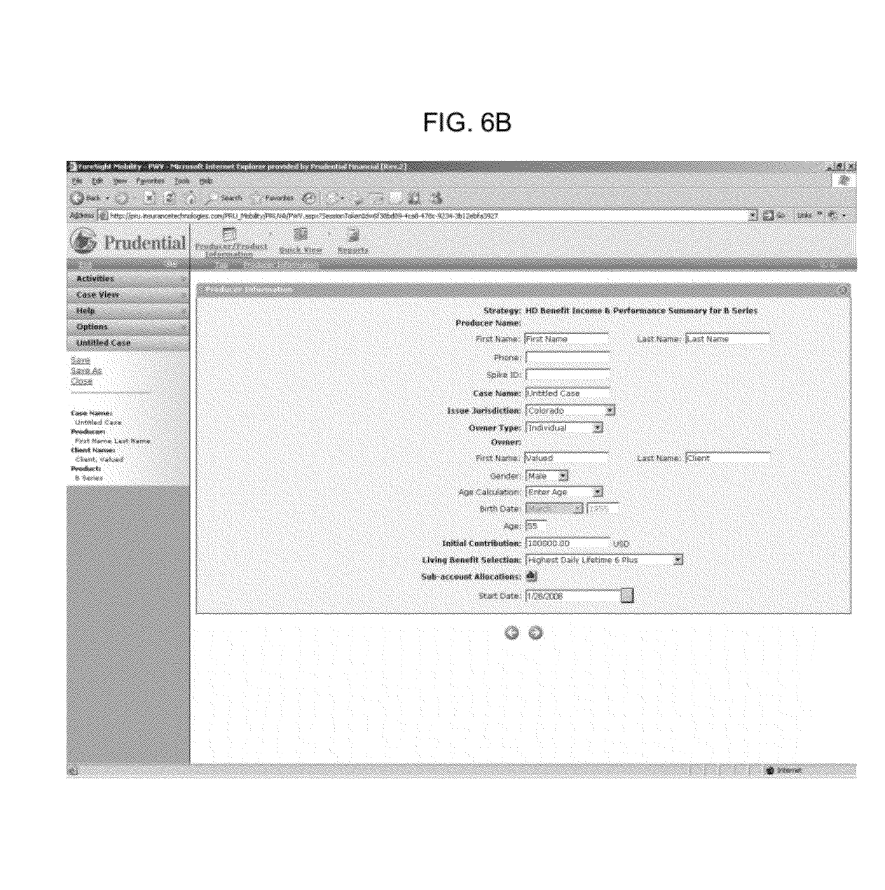

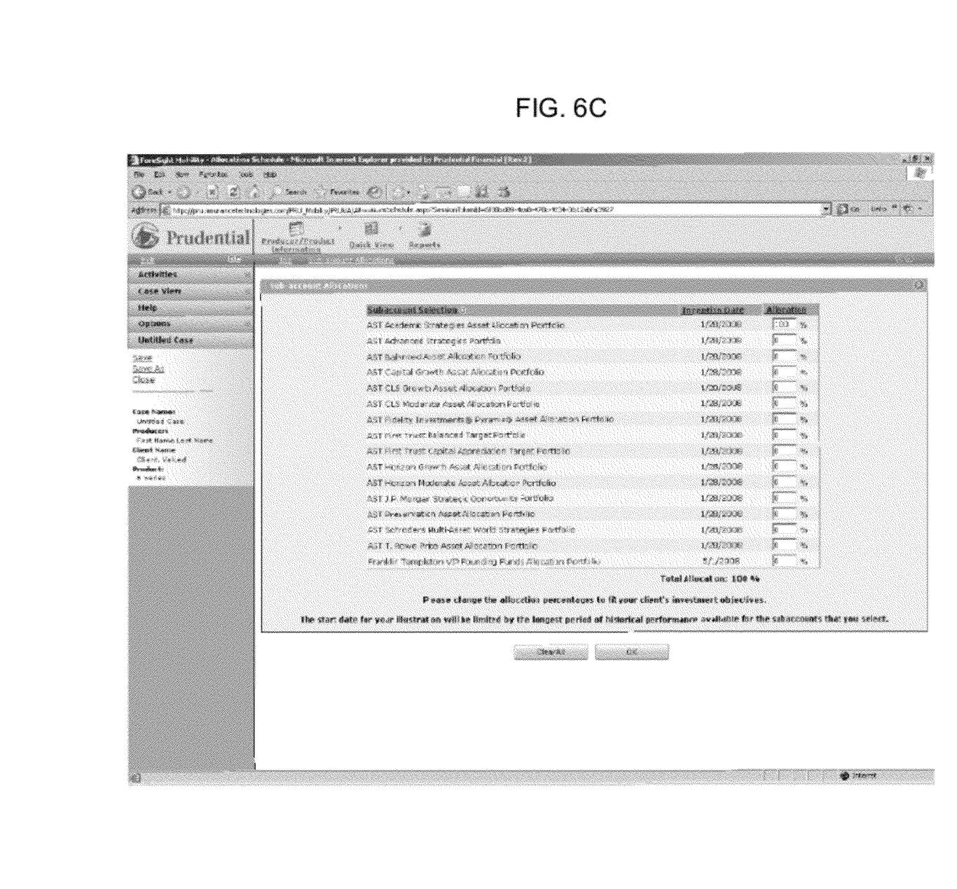

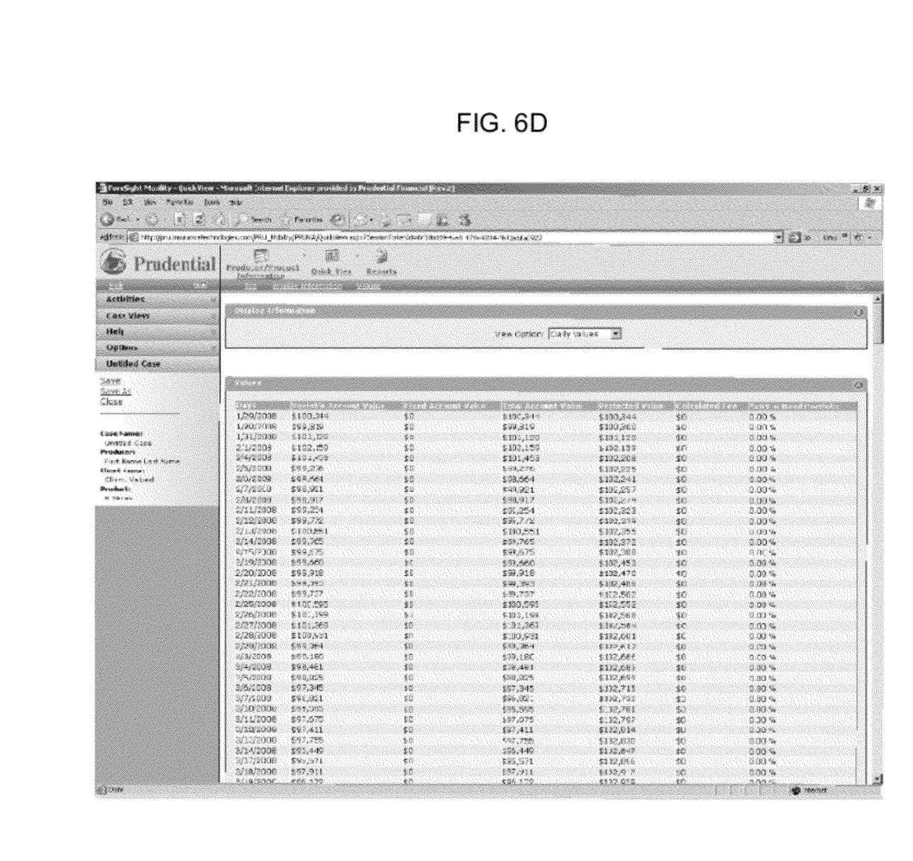

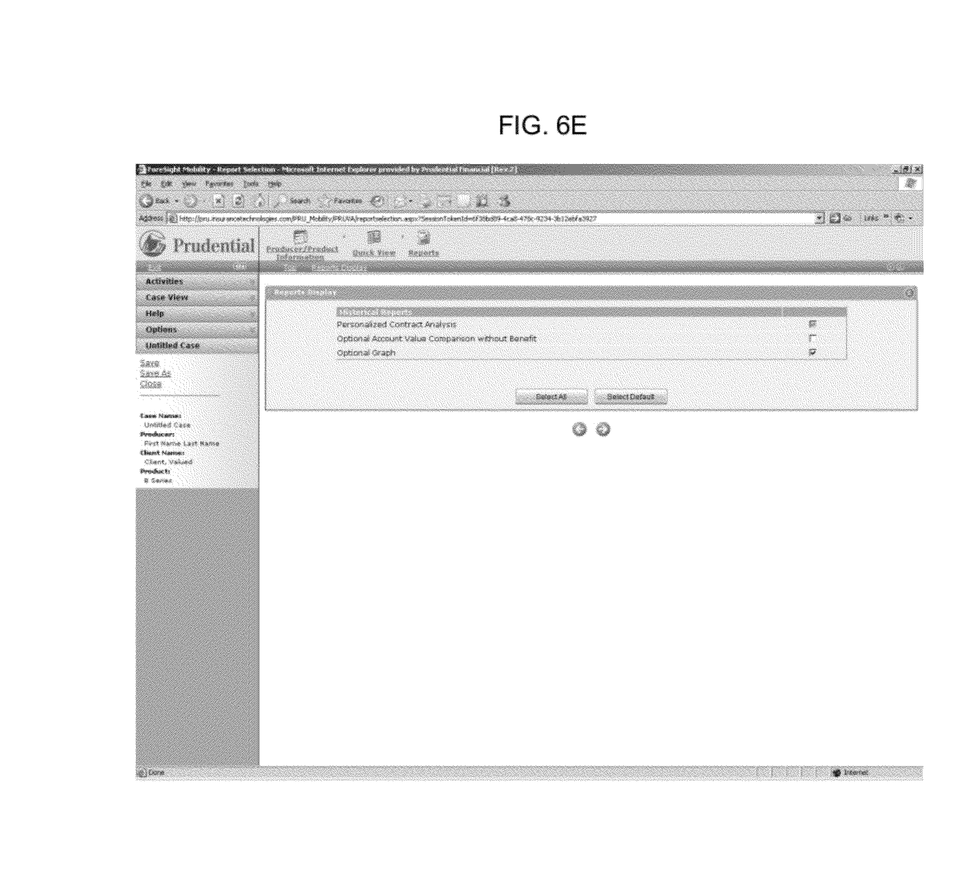

FIGS. 6A-6E are screenshots of the user interface generated by the present invention, for allowing a user to illustrate and conduct a comparison of a variable annuity financial product when one or more benefits are provided with the variable annuity financial product. The screens shown in FIGS. 6A-6E could be displayed in a conventional web browser operating on any desired computing system, such as the devices 52-56 and 62-66 shown in FIG. 1 and described above. As can be seen in FIG. 6A, the user interface permits the user to select a variable annuity financial product to be illustrated. Optionally, the user could also specify information about a financial institution that the user is associated with (“channel” name and firm name), as well as name associated with the illustration to be performed. As shown in FIG. 6B, the user is then provided with a second screen which allows the user to provide additional information about him/herself, as well as other information associated with the illustration to be performed, such as the case name, issuing jurisdiction, owner name, gender, age calculation, birth date, age, initial contribution (premium) amount, whether or not an option associated with the variable annuity financial product (e.g., living benefit, protected withdrawal option, etc.) is to be included in the illustration, and illustration start date.

If allocations are desired for one or more portfolios (subaccounts) of the variable annuity financial product, the user clicks an icon shown in FIG. 6B and labeled “Sub-account Allocations,” and is provided with the screen shown in. FIG. 6C. As can be seen, the screen shown in FIG. 6C allows the user to specify percentages of the variable annuity financial product to be allocated to one or more portfolios (sub-accounts) of the financial product, for the illustration.

As mentioned above, once the illustration has been generated, it could be displayed to the user in any desired format, such as in graph or tabular format. Tabular illustration results are shown in FIG. 6D. As can be seen, the table lists each day in the illustration, as well as various account values and fees, and the percentage of account value that is allocated to a bond portfolio. Also, as shown in FIG. 6E, the user can select (toggle) display options for the illustration. For example, the user can specify whether the illustration should include an optional personalized contract analysis, whether a graph is generated, and whether to display a comparison of the financial product to a financial product having an option associated therewith, such as a living benefit. Further, the user could click on the “Quick View” icon located at the top of the screen, to be provided with a short-form illustration that can quickly be viewed by the user.

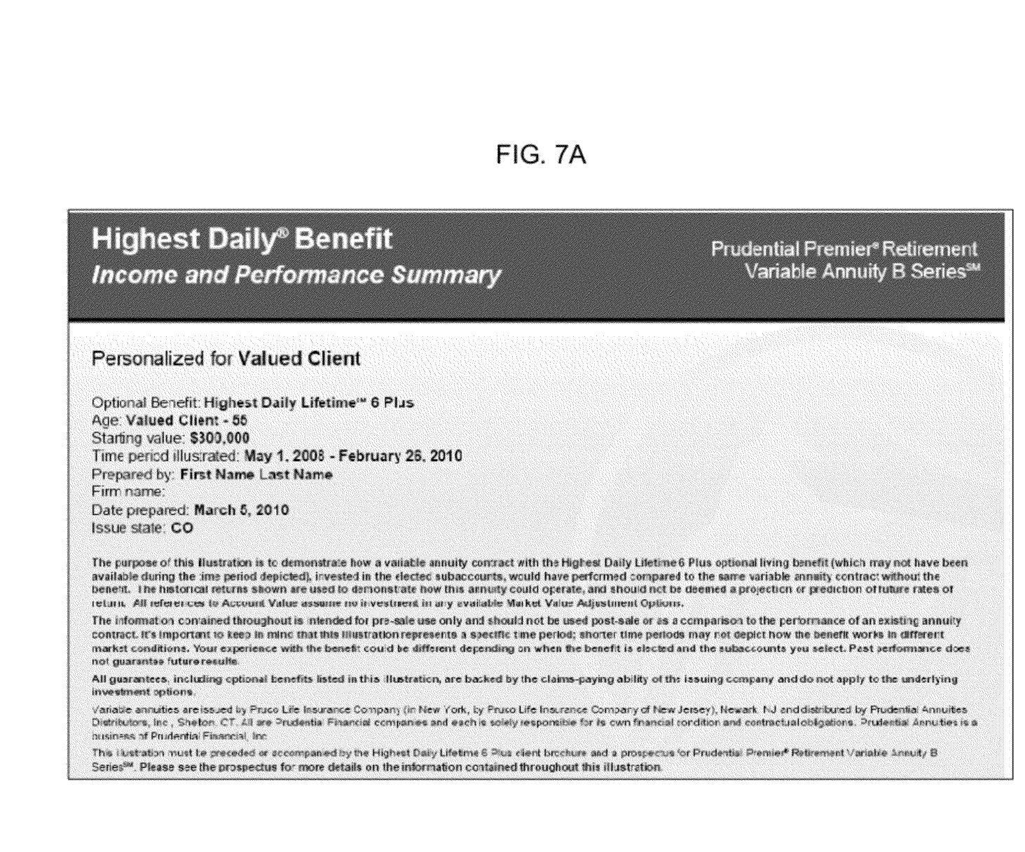

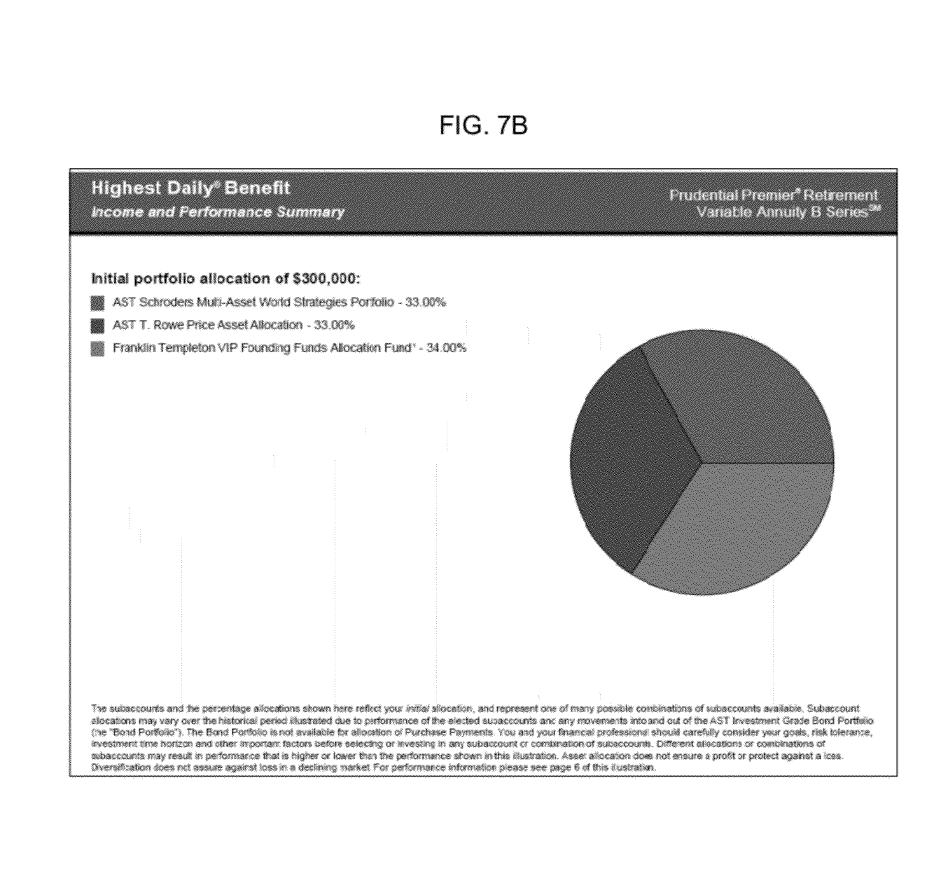

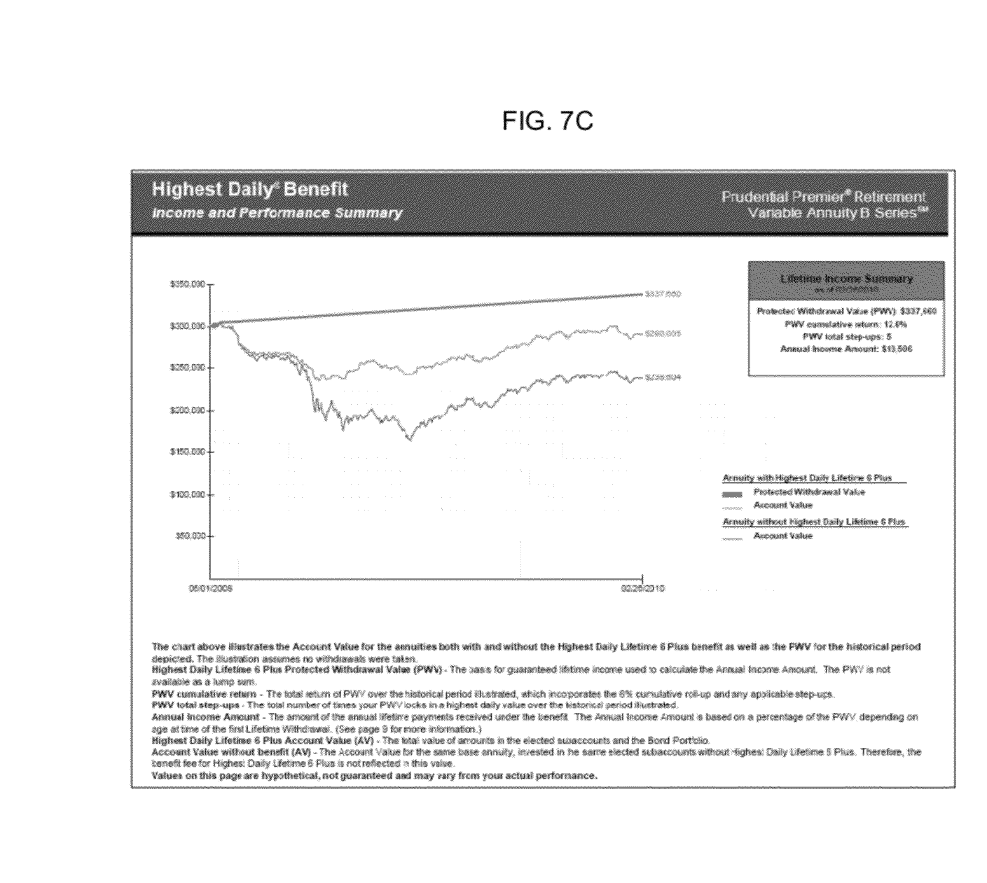

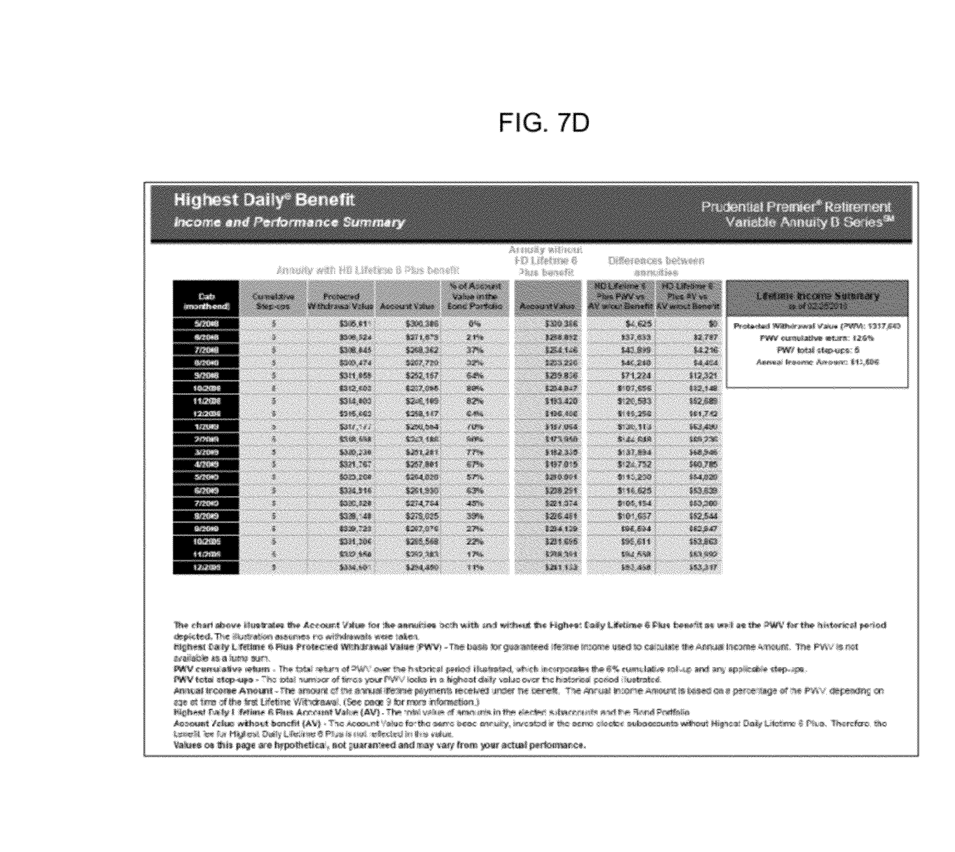

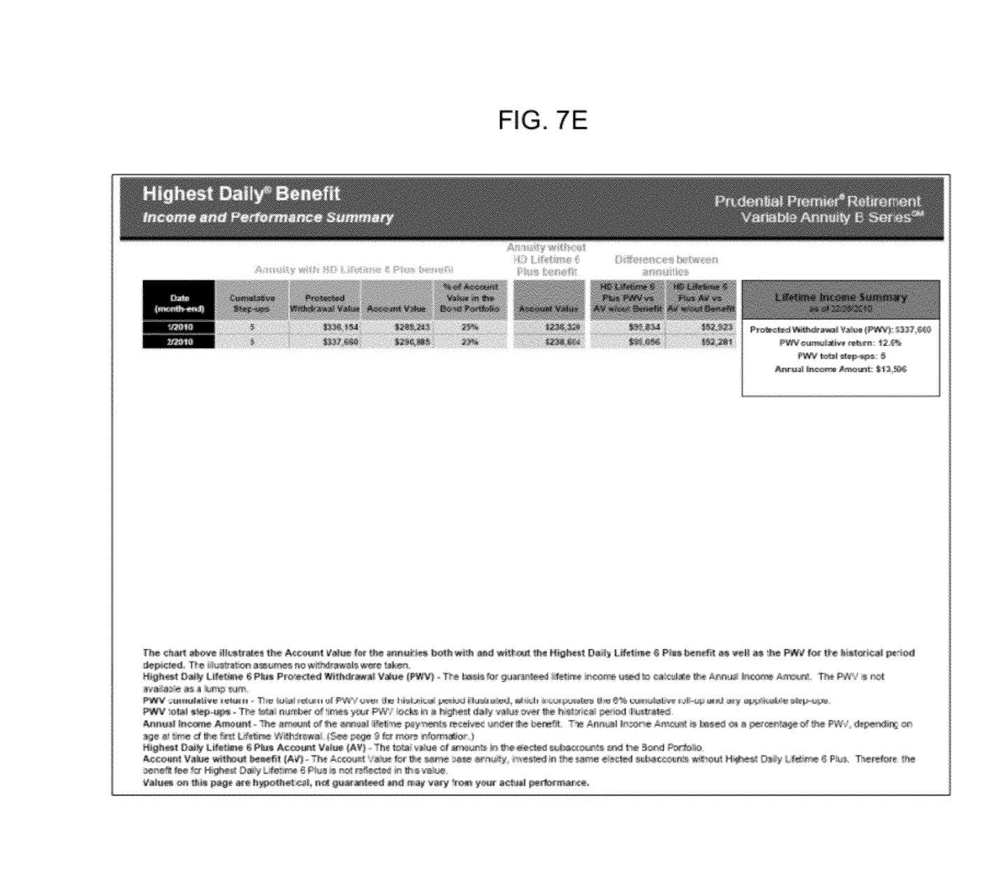

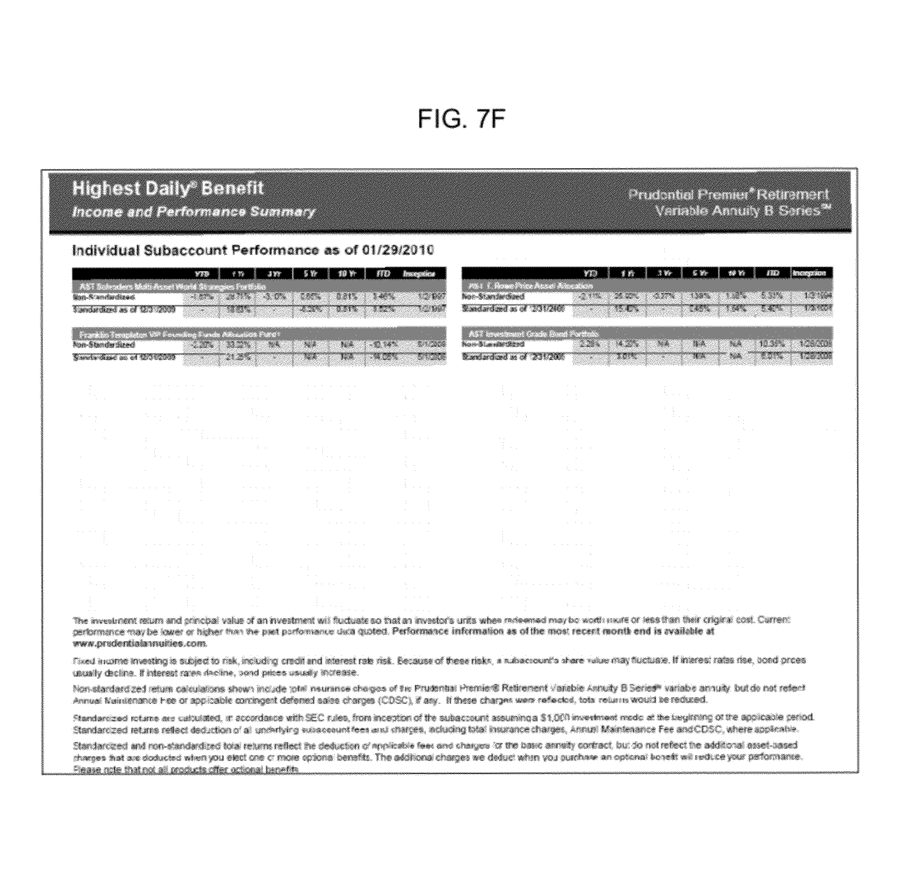

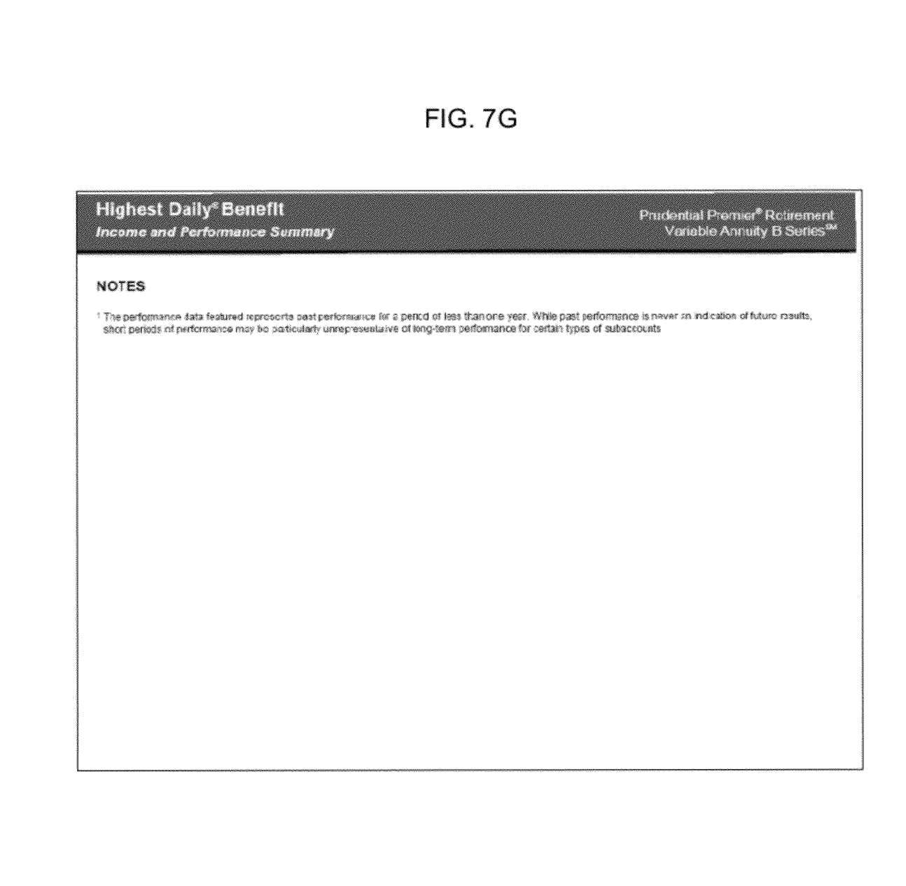

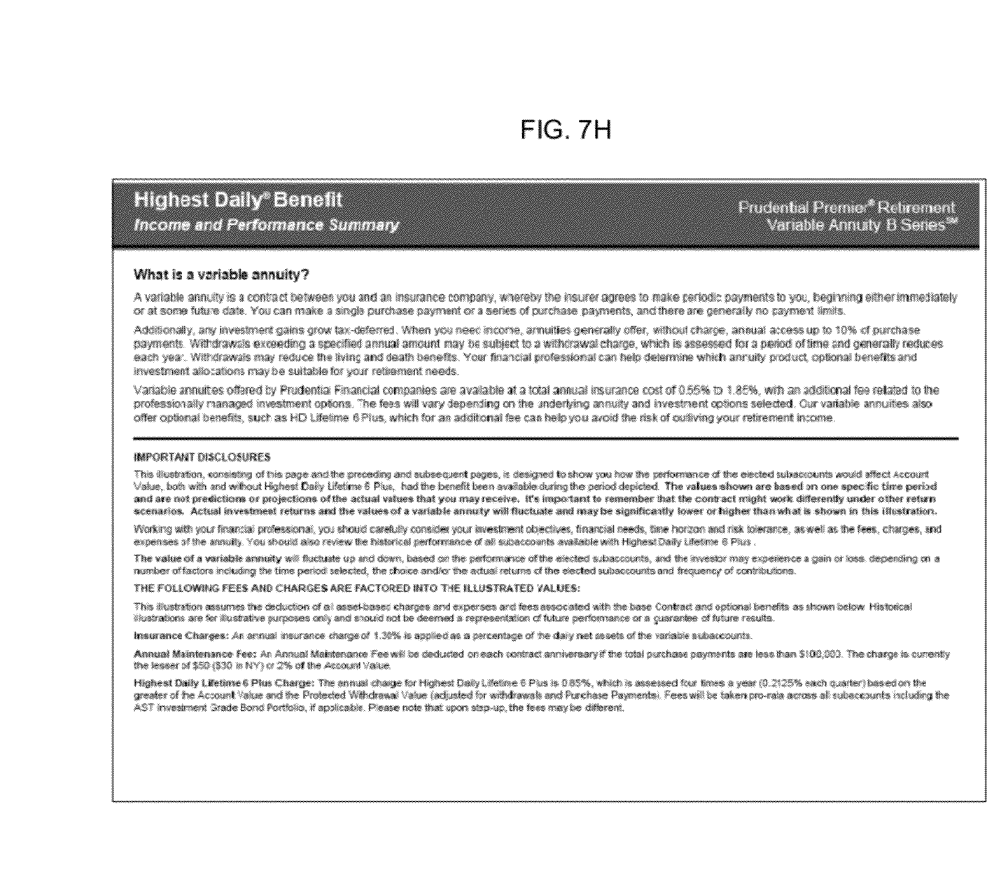

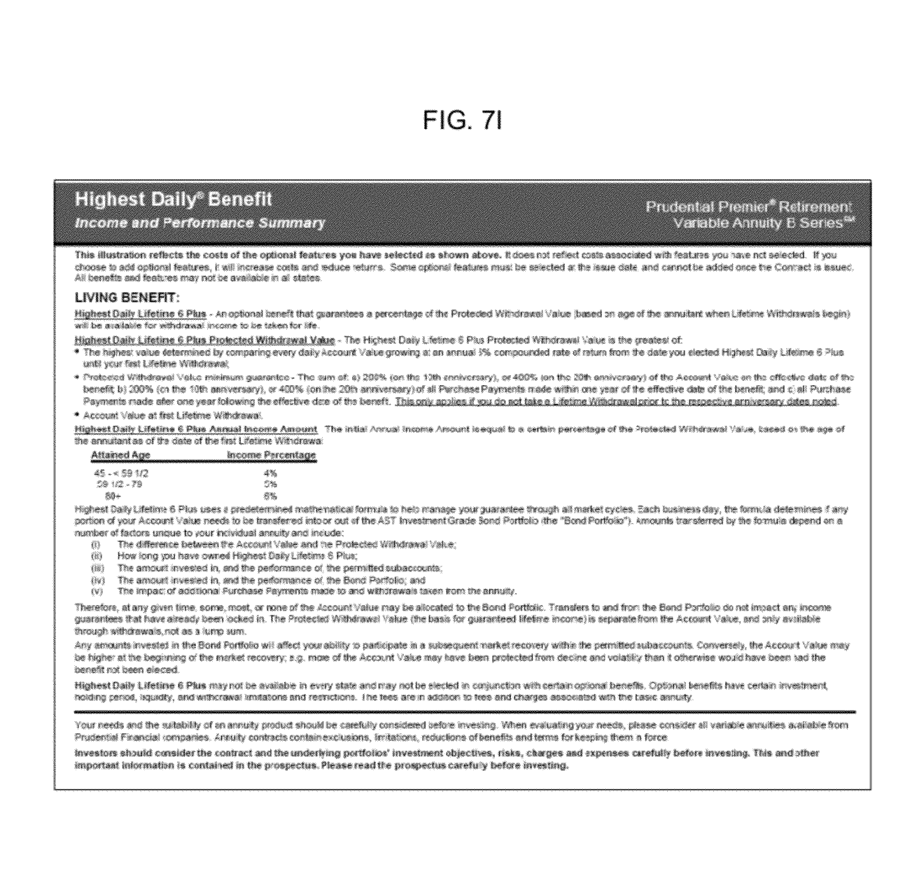

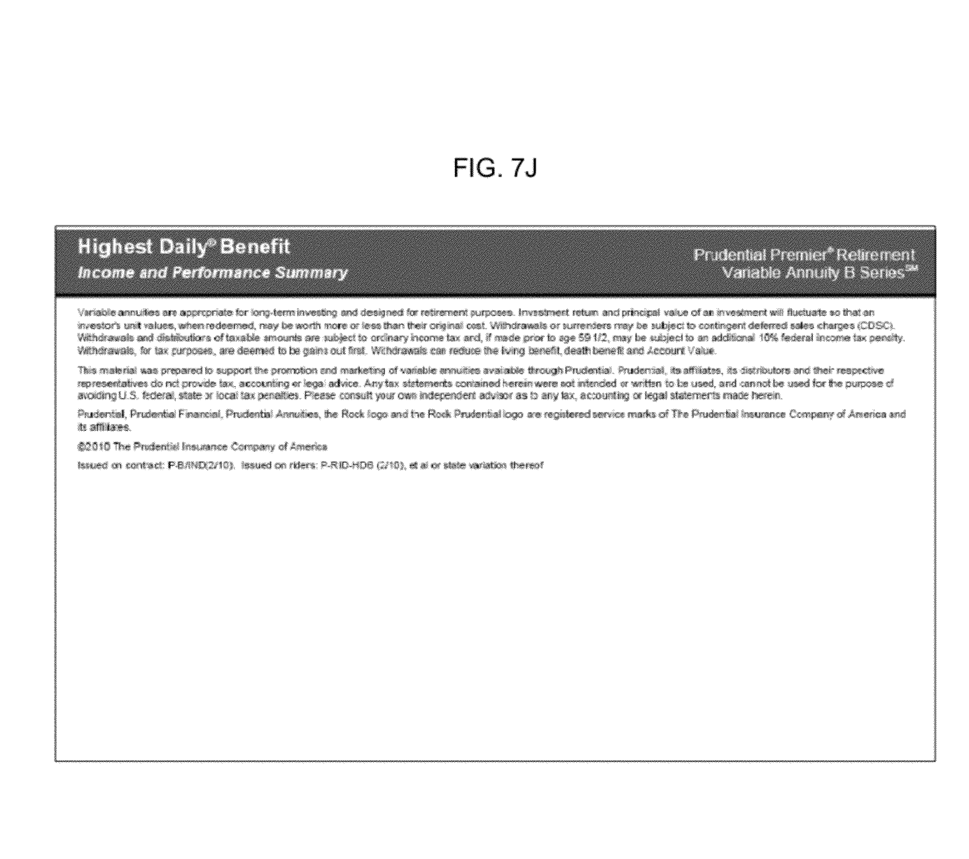

FIGS. 7A-7J are screenshots of a sample illustration report provided by the present invention. As can be seen in FIG. 7A, the report includes a summary page which identifies the variable annuity financial product being illustrated, the client's age, the starting (premium) value for the variable annuity financial product, the time period of the illustration, the name of the person preparing the report, his or her firm name, the date of generation of the report, and the state in which the variable annuity financial product was issued. Explanatory notes are also provided at the bottom of the summary page.

As can be seen in FIG. 7B, the report includes an asset allocation chart which shows (in pie chart or other format) the allocations (in percentages) of portfolios forming part of the variable annuity financial product. These allocations are defined by the user, and control the illustration process.

As shown in FIG. 7C, the illustration report includes an illustration results page which includes optional graphs showing actual performance of the variable annuity financial product during the illustration time period (based upon historical performance data) as well as performance of the product when a living benefit and a protected withdrawal benefit is provided. The total value of the variable annuity financial product, in each scenario, is also displayed. This provides a convenient and easy-to-interpret representation of the variable annuity financial products' performance, and allows a user to compare performance of the variable annuity financial product when one or more benefits are provided. Additionally, the results page displays the calculated protected withdrawal cumulative return (mentioned above), as well as the total number of PWV step-ups and the calculated annual income amount. Of course, income amounts on a basis other than annual basis could also be included in the report.

As shown in FIGS. 7D-7E, the illustration report also presents illustration results in tabular format, listing month-end results for each month in the illustration. Further, as shown in FIG. 7F, the illustration report includes a page which displays performance of individual portfolios (subaccounts) forming part of the variable annuity financial product. Such a page provides an additional level of detail for the user. As shown in FIGS. 7G-7J, the illustration report includes pages of explanatory notes which guide the user in interpreting and understanding the illustration report and its various parameters.

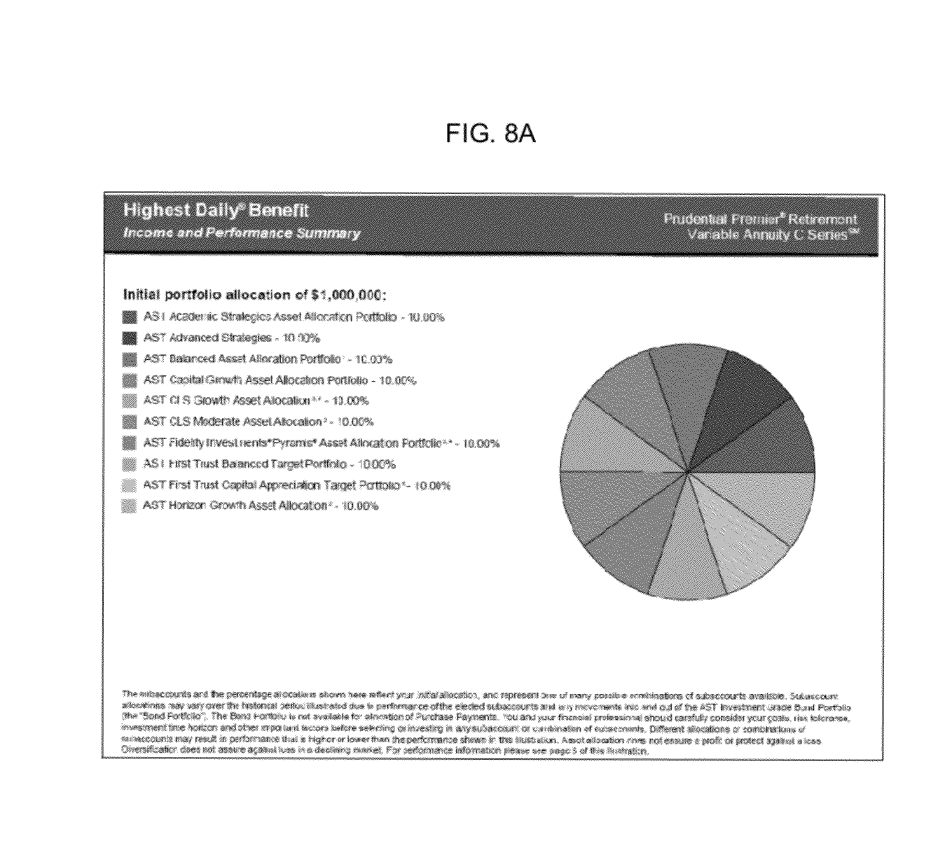

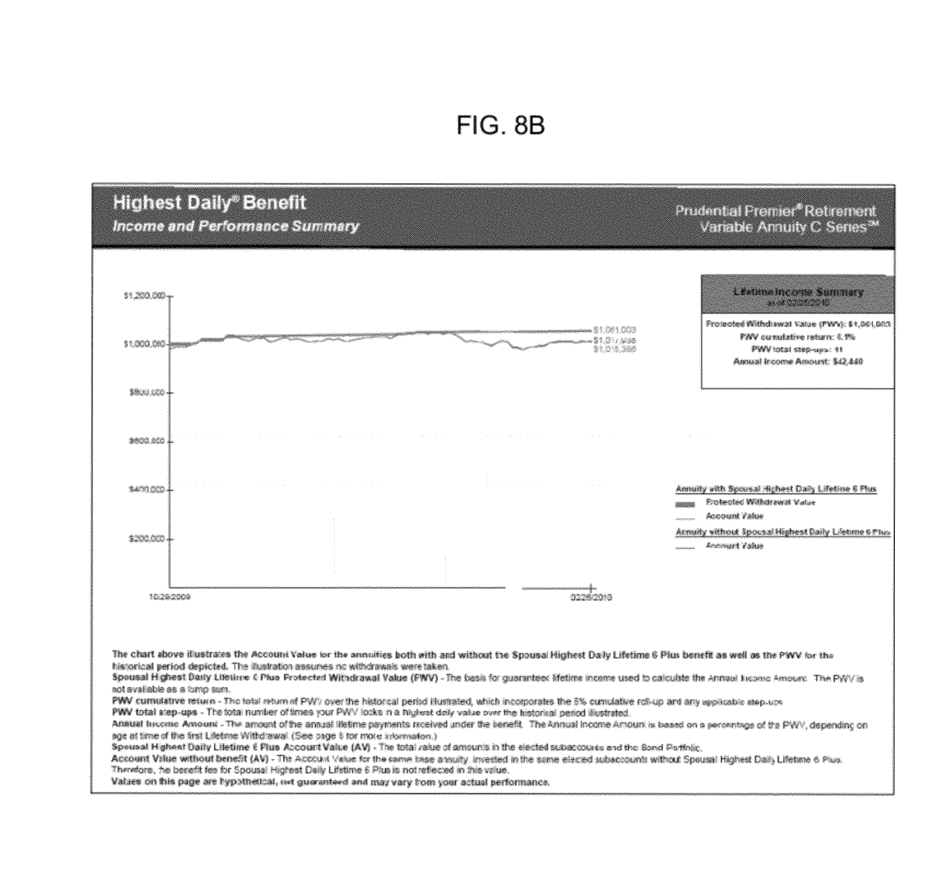

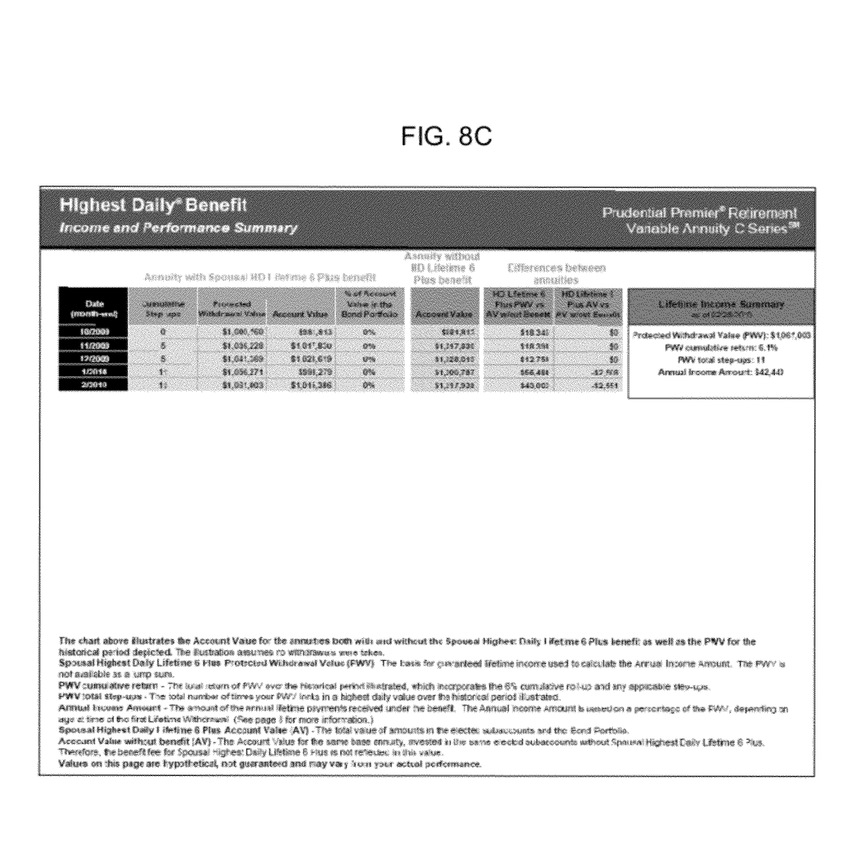

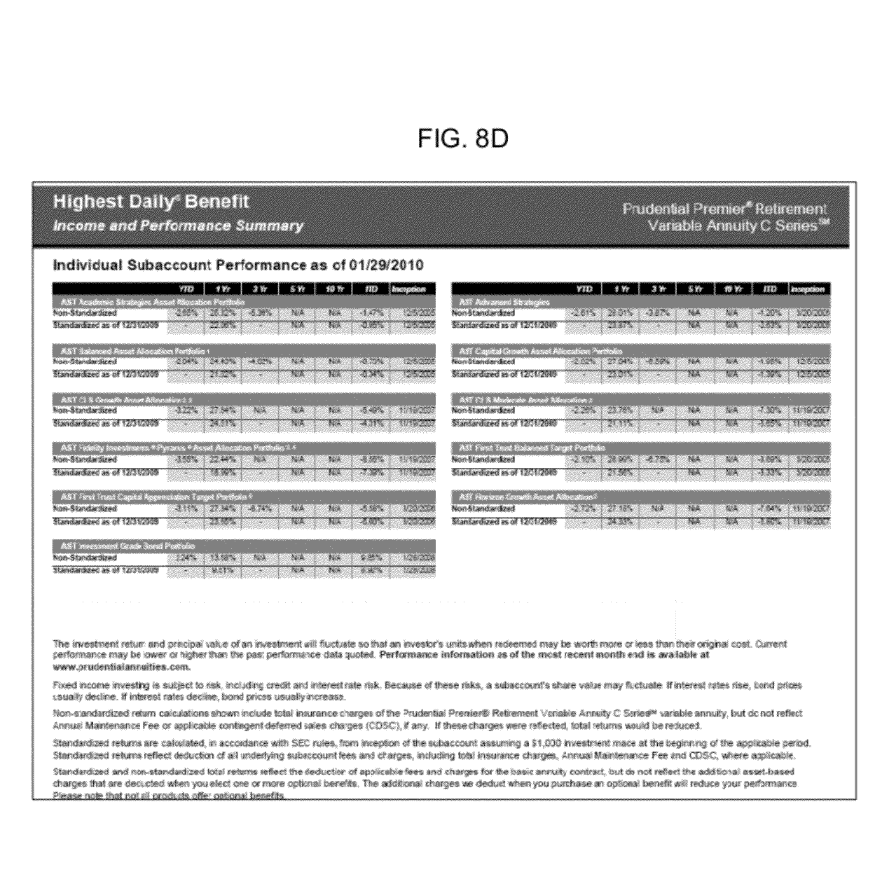

It is noted that the present invention could be applied to illustrate a variable annuity financial product having numerous portfolios. Excerpts of an illustration report for such a scenario are shown in FIGS. 8A-8D. As can be seen, ten portfolios are illustrated for a variable annuity financial product. As can be appreciated, the present invention provides significant flexibility in the number of portfolios that can be illustrated, as well as illustration parameters desired by the user.

It shall be understood by those skilled in the art that the text shown in FIGS. 6A-8D include financial and/or educational disclosures made to a consume, for example, the text shown in FIGS. 7H-7J. These financial and/or educational disclosures shall be understood as being exemplary of text having information for consumer consideration, and not as being limiting on the scope of the invention defined by the appended claims.

It is further noted that the illustrations of the present invention could be performed for two or more variable annuity financial products, and results displayed to a user in a single report. In such fashion, the user could compare the actual performance of two of the variable annuity financial products over a modeled time period, and could use such information in deciding how to handle future investments for such products. The illustration results of the present invention could be integrated with a customer relations management (CRM) software application/platform, so that a financial services professional can contact/follow up with a user after an illustration has been performed. It is noted that illustrations could also be performed using hypothetical financial performance data, in addition to and/or in place of actual financial performance data, corresponding to one or more portfolios to be illustrated.

Having thus described the invention in detail, it is to be understood that the foregoing description is not intended to limit the spirit or scope thereof. What is desired to be protected is set forth in the following claims.

What is claimed is:

1. A system for illustrating a variable annuity financial product, comprising:
a local computer system operated by a user, the local computer system generating at least one user interface screen for allowing the user to specify information about a variable annuity financial product to be illustrated and a desired start date for a financial illustration;
an illustration server in communication with the local computer system, the illustration server receiving the information about the variable annuity financial product and the desired start date from the local computer system;
means for electronically obtaining historical performance data on a daily basis relating to at least one portfolio of the variable annuity financial product;
means for calculating performance data for at least one portfolio having a benefit associated with the variable annuity financial product;
means at the illustration server for modeling the variable annuity financial product from the start date to an end date to produce a first illustration for the variable annuity financial product and for modeling the variable annuity financial product with at least one benefit associated with the variable annuity financial product for the same time period to produce a second illustration for the variable annuity financial product, for comparison of the variable annuity financial product with and without the at least one benefit;
means for generating an illustration report for the user, the illustration report including the first and second illustrations; and
means for transmitting the illustration report to the user and displaying the report to the user on the local computer system.

2. The system of claim 1, wherein the option comprises a living benefit associated with the variable annuity financial product.

3. The system of claim 1, wherein the benefit comprises a guaranteed minimum return value for the variable annuity financial product.

4. The system of claim 3, further comprising means for calculating a cumulative return value for the financial product, the illustration report including the calculated cumulative return value.

5. The system of claim 3, further comprising means for calculating a total number of increases in account value, the illustration report including the calculated total number of increases in account value.

6. The system of claim 3, further comprising means for calculating an annual income amount for the financial product, the illustration report including the annual income amount.

7. The system of claim 1, further comprising means for calculating final account values for the variable annuity financial product for each of the first illustration and the second illustration, the illustration report including the final account values.

8. The system of claim 1, wherein the illustration report further comprises a plurality of graphs for displaying the first and second illustrations of the variable annuity financial product.

9. The system of claim 1, wherein the illustration report further comprises a plurality of tables for displaying the first and second illustrations of the variable annuity financial product.

10. The system of claim 1, wherein the user interface allows the user to specify a plurality of portfolios associated with the variable annuity financial product for inclusion in the financial illustration.

11. The system of claim 10, wherein the user interface allows the user to adjust allocations associated with each of the plurality of portfolios prior to the financial illustration.

12. The system of claim 1, wherein the means for modeling the variable annuity financial product models the financial product on a daily basis.

13. A method for illustrating a variable annuity financial product, comprising the steps of:
generating at least one user interface screen at a local computer operated by a user;
allowing the user to specify information about a variable annuity financial product to be illustrated and a start date for a financial illustration, using the at least one user interface screen;
transmitting the information about the variable annuity financial product and the start date from the local computer system to an illustration server in communication with the local computer system;
electronically obtaining historical performance data on a daily basis relating to at least one portfolio of the variable annuity financial product;
calculating performance data for at least one portfolio having a benefit associated with the variable annuity financial product;
modeling the variable annuity financial product from the start date to an end date using the illustration server to produce a first illustration for the variable annuity financial product;
modeling the variable annuity financial product with at least one benefit associated with the variable annuity financial product for the same time period using the illustration server to produce a second illustration for the variable annuity financial product;
generating an illustration report for the user, the illustration report including the first and second illustrations for comparison of the variable annuity financial product with and without the at least one benefit;
transmitting the illustration report to the local computer system; and
displaying the report to the user on the local computer system.

14. The method of claim 13, wherein the step of modeling the variable annuity financial product with the at least one benefit associated with the variable annuity financial product comprises modeling the financial product with a living benefit associated with the variable annuity financial product.

15. The method of claim 13, wherein the step of modeling the variable annuity financial product with the at least one benefit associated with the variable annuity financial product comprises modeling the variable annuity financial product with a guaranteed minimum return value for the variable annuity financial product.

16. The method of claim 15, further comprising calculating a cumulative return value for the variable annuity financial product and including the calculated cumulative return value in the illustration report.

17. The method of claim 15, further comprising calculating a total number of increases in account value and including the calculated total number of increases in account value in the illustration report.

18. The method of claim 15, further comprising calculating an annual income amount for the financial product and including the annual income amount in the illustration report.

19. The method of claim 13, further comprising calculating final account values for the financial product for the first illustration and for the second illustration, and including the final account values in the illustration report.

20. The method of claim 13, further comprising generating a plurality of graphs for displaying the first and second illustrations of the variable annuity financial product and including the plurality of graphs in the illustration report.

21. The method of claim 13, further comprising generating a plurality of tables for displaying the first and second illustrations of the variable annuity financial product and including the plurality of tables in the illustration report.

22. The method of claim 13, further comprising specifying using the user interface a plurality of portfolios associated with the variable annuity financial product for inclusion in the financial illustration.

23. The method of claim 22, further comprising adjusting allocations associated with each of the plurality of portfolios prior to the financial illustration using the user interface.

24. The method of claim 13, wherein the steps of modeling the variable annuity financial product over the desired time period and modeling the variable annuity financial product with at least one benefit associated with the financial product are each conducted on a daily basis.

25. A computer-readable storage medium comprising computer-readable instructions for instructing at least one computer system to generate an illustration of a variable annuity financial product, the instructions causing the at least one computer system to execute the steps of:
electronically obtaining information from a user about a variable annuity financial product to be illustrated and a desired start date for a financial illustration;
electronically obtaining historical performance data on a daily basis relating to at least one portfolio of the variable annuity financial product;
calculating performance data for at least one portfolio having a benefit associated with the variable annuity financial product;
modeling the variable annuity financial product from the start date to an end date using the illustration server to produce a first illustration for the variable annuity financial product;
modeling the variable annuity financial product with at least one benefit associated with the variable annuity financial product for the same time period using the illustration server to produce a second illustration for the variable annuity financial product;
generating an illustration report for the user, the illustration report including the first and second illustrations for comparison of the variable annuity financial product with and without the at least one benefit;
transmitting the illustration report to the local computer system; and
displaying the report to the user on the local computer system

26. The computer-readable storage medium of claim 25, wherein the step of modeling the variable annuity financial product with the at least one benefit associated with the variable annuity financial product comprises modeling the variable annuity financial product with a living benefit associated with the variable annuity financial product.

27. The computer-readable storage medium of claim 25, wherein the step of modeling the variable annuity financial product with the at least one benefit associated with the variable annuity financial product comprises modeling the variable annuity financial product with a guaranteed minimum return value for the variable annuity financial product.

28. The computer-readable storage medium of claim 27, further comprising the step of calculating a cumulative return value for the variable annuity financial product and including the calculated cumulative return value in the illustration report.

29. The computer-readable storage medium of claim 27, further comprising calculating a total number of increases in account value and including the calculated total number of increases in account value in the illustration report.

30. The computer-readable storage medium of claim 27, further comprising calculating an annual income amount for the variable annuity financial product and including the annual income amount in the illustration report.

31. The computer-readable storage medium of claim 25, further comprising calculating final account values for the variable annuity financial product for each of the first illustration and the second illustration and including the final account values in the illustration.

32. The computer-readable storage medium of claim 25, further comprising generating a plurality of graphs for displaying the first and second illustrations of the variable annuity financial product and including the plurality of graphs in the illustration report.

33. The computer-readable storage medium of claim 25, further comprising generating a plurality of tables for displaying the first and second illustrations of the variable annuity financial product and including the plurality of tables in the illustration report.

34. The computer-readable storage medium of claim 25, further comprising electronically obtaining information from the user about a plurality of portfolios associated with the variable annuity financial product for inclusion in the financial illustration.

35. The computer-readable storage medium of claim 34, further comprising adjusting allocations associated with each of the plurality of portfolios prior to the financial illustration.

36. The computer-readable storage medium of claim 25, wherein the steps of modeling the variable annuity financial product and modeling the variable annuity financial product with the at least one benefit associated with the variable annuity financial product are each conducted on a daily basis.

37. A system for providing a variable annuity financial product illustration, said system comprising at least one computer readable medium having stored thereon program code, which, when executed, causes execution comprising the following steps:
providing information about at least one portfolio of a variable annuity financial product to be illustrated and a desired time period including desired start date for illustration;
providing historical performance data on a daily basis relating to the at least one portfolio;
calculating performance data for the at least one portfolio;
modeling (a) the at least one portfolio from the start date to an end date to produce a first illustration and (b) the at least one portfolio with at least one benefit for the same time period to produce a second illustration; and
generating an illustration report based on the first and second illustrations for comparison of the at least one portfolio with and without the at least one benefit.

38. The system of claim 37, wherein providing the historical performance data comprises electronically obtaining the historical data from a financial products database.

39. The system of claim 37, wherein providing the information and the desired time period comprises electronically receiving the information and the desired time period from an electronic device local to a user.

40. The system of claim 39 comprising an illustration server.

41. The system of claim 40, wherein said illustration server comprises said at least one computer readable medium.

42. The system of claim 39, wherein the program code, when executed by the computerized system, causes execution comprising the following step:
providing the illustration report to the electronic device.

43. The system of claim 42, wherein providing the illustration report to the electronic device comprises transmitting the illustration report to the electronic device.

44. The system of claim 39, comprising the electronic device.

45. The system of claim 44, wherein said at least one computer readable medium includes a plurality of computer readable media distributed at least across an illustration server and said electronic device.

46. The system of claim 45, wherein the program code, when executed, causes execution comprising:
generating at said electronic device at least one user interface screen for allowing the user to specify the information and the desired time period; and
transmitting the information and the desired time period to the illustration server.

47. The system of claim 46, wherein the program code, when executed, causes execution comprising:
displaying the illustration report on the electronic device.

48. The system of claim 37, wherein the at least one portfolio includes a plurality of portfolios.

49. The system of claim 48, wherein the information includes an inter-portfolio allocation of the plurality of portfolios.
